(19) United States
(12) Patent Application Publication
(10) Pub. No.: US 2025/0180959 A1
(43) Pub. Date: Jun. 5, 2025

(54) ELECTROPHORETIC MEDIA COMPRISING CATIONIC CHARGE CONTROL AGENT

(71) Applicant: E INK CORPORATION, Billerica, MA (US)

(72) Inventor: Eugene BZOWEJ, Dunstable, MA (US)

(21) Appl. No.: 18/953,823

(22) Filed: Nov. 20, 2024

Related U.S. Application Data
(60) Provisional application No. 63/604,274, filed on Nov. 30, 2023.

(51) Int. Cl. G02F 1/167; G02F 1/1675; G02F 1/16757; G02F 1/1676

(52) U.S. Cl. CPC G02F 1/167; G02F 1/16757; G02F 1/1676; G02F 2001/1678

(57) ABSTRACT

Electrophoretic media are disclosed containing a plurality of charged pigment particles, a charge control agent, and a non-polar liquid. The charge control agents has a molecular structure comprising a quaternary ammonium functional group or an imidazolium cation, a hydrophobic tail, and a counter ion, the counter ion being an anion, the anion being a conjugate base of an acid, the acid having pKa of less than or equal to −2.5.

### RELATED APPLICATIONS

This application claims priority to U.S. Provisional Patent Application No. 63/604,274 filed on Nov. 30, 2023, which is incorporated by reference in its entirety, along with all other patents and patent applications disclosed herein.

### FIELD OF THE INVENTION

This invention relates to electrophoretic media for electro-optic devices, the electrophoretic media comprising a plurality of charged particles and a charge control agent in a non-polar liquid. In one aspect, this invention relates to electrophoretic media comprising a charge control agent, the molecular structure of which has a quaternary ammonium functional group or an imidazolium cation, and a counter ion, the counter ion being an anion, the anion being a conjugate base of an acid, the acid having a pKa of less than or equal to −2.5.

### BACKGROUND OF THE INVENTION

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

Particle-based electrophoretic displays have been the subject of intense research and development for a number of years. In such displays, a plurality of charged particles (sometimes referred to as pigment particles or charged pigment particles) move through a fluid under the influence of an electric field. The electric field is typically provided by a conductive film or a transistor, such as a field-effect transistor. Electrophoretic displays have good brightness and contrast, wide viewing angles, state bistability, and low power consumption when compared with liquid crystal displays. Such electrophoretic displays have slower switching speeds than LCD displays, however, and electrophoretic displays are typically too slow to display real-time video. Additionally, the electrophoretic displays can be sluggish at low temperatures because the viscosity of the fluid limits the movement of the electrophoretic charged particles. Despite these shortcomings, electrophoretic displays can be found in everyday products such as electronic books (e-readers), mobile phones and mobile phone covers, smart cards, signs, watches, shelf labels, and flash drives.

The term “gray state” is used herein in its conventional meaning in the imaging art to refer to a state intermediate two extreme optical states of a pixel and does not necessarily imply a black-white transition between these two extreme states. For example, several of the E Ink patents and published applications referred to below describe electrophoretic displays in which the extreme states are white and deep blue, so that an intermediate “gray state” would actually be pale blue. Indeed, as already mentioned, the change in optical state may not be a color change at all. The terms “black” and “white” may be used hereinafter to refer to the two extreme optical states of a display and should be understood as normally including extreme optical states which are not strictly black and white, for example the aforementioned white and dark blue states. The term “monochrome” may be used hereinafter to denote a drive scheme which only drives pixels to their two extreme optical states with no intervening gray states.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays and encapsulated liquid crystal displays.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

One type of electro-optic display, which has been the subject of intense research and development for a number of years, is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

Numerous patents and applications assigned to or in the names of the Massachusetts Institute of Technology (MIT), E Ink Corporation, E Ink California, LLC. and related companies describe various technologies used in encapsulated and microcell electrophoretic and other electro-optic media. Encapsulated electrophoretic media comprise numerous small capsules, each of which itself comprises an electrophoretic medium containing electrophoretically-mobile particles in a fluid medium, and a capsule wall surrounding the electrophoretic medium. Typically, the capsules are themselves held within a polymeric binder to form a coherent layer positioned between two electrodes. In a microcell electrophoretic display, the charged particles and the fluid are not encapsulated within microcapsules but instead are retained within a plurality of cavities formed within a carrier medium, typically a polymeric film. [[Hereinafter, the term “microcavity electrophoretic display” may be used to cover both encapsulated and microcell electrophoretic displays.]] The technologies described in these patents and applications include:
(a) Electrophoretic particles, fluids and fluid additives; see for example U.S. Pat. Nos. 7,002,728 and 7,679,814, and U.S. Patent Applications Publication Nos. 2020/0355978, 2024/0279391, and 2023/0213790;
(b) Capsules, binders and encapsulation processes; see for example U.S. Pat. Nos. 6,922,276 and 7,411,719:
(c) Microcell structures, wall materials, and methods of forming microcells; see for example U.S. Pat. Nos. 7,072,095 and 9,279,906;
(d) Methods for filling and sealing microcells; see for example U.S. Pat. Nos. 7,144,942 and 7,715,088;
(e) Films and sub-assemblies containing electro-optic materials; see for example U.S. Pat. Nos. 6,982,178 and 7,839,564;
(f) Backplanes, adhesive layers and other auxiliary layers and methods used in displays; see for example U.S. Pat. Nos. 7,116,318 and 7,535,624;
(g) Color formation and color adjustment; see for example U.S. Pat. Nos. 7,075,502 and 7,839,564;
(h) Methods for driving displays; see for example U.S. Pat. Nos. 7,012,600 and 7,453,445;
(i) Applications of displays; see for example U.S. Pat. Nos. 7,312,784 and 8,009,348; and
(j) Non-electrophoretic displays, as described in U.S. Pat. Nos. 6,241,921 and U.S. Patent Applications Publication No. 2015/0277160; and applications of encapsulation and microcell technology other than displays; see for example U.S. Patent Application Publications Nos. 2015/0005720 and 2016/0012710.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode may be useful in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively.

An electrophoretic display normally comprises a layer of electrophoretic material and at least two other layers disposed on opposed sides of the electrophoretic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode and the other electrode layer is patterned into a matrix of pixel electrodes, each of which defines one pixel of the display. In another type of electrophoretic display, which is intended for use with a stylus, print head or similar movable electrode separate from the display, only one of the layers adjacent the electrophoretic layer comprises an electrode, the layer on the opposed side of the electrophoretic layer typically being a protective layer intended to prevent the movable electrode damaging the electrophoretic layer.

The manufacture of a three-layer electrophoretic display normally involves at least one lamination operation. For example, in several of the aforementioned MIT and E Ink patents and applications, there is described a process for manufacturing an encapsulated electrophoretic display in which an encapsulated electrophoretic medium comprising capsules in a binder is coated on to a flexible substrate comprising indium-tin-oxide (ITO) or a similar conductive coating (which acts as a first electrode of the final display) on a plastic film, the capsules/binder coating being dried to form a coherent layer of the electrophoretic medium firmly adhered to the substrate. Separately, a backplane, containing an array of pixel electrodes and an appropriate arrangement of conductors to connect the pixel electrodes to drive circuitry, is prepared. To form the final display, the substrate having the capsule/binder layer thereon is laminated to the backplane using a lamination adhesive. (A very similar process can be used to prepare an electrophoretic display usable with a stylus or similar movable electrode by replacing the backplane with a simple protective layer, such as a plastic film, over which the stylus or other movable electrode can slide.) In one preferred form of such a process, the backplane is itself flexible and is prepared by printing the pixel electrodes and conductors on a plastic film or other flexible substrate. The obvious lamination technique for mass production of displays by this process is roll lamination using a lamination adhesive.

As discussed in the aforementioned U.S. Pat. No. 6,982,178, (see column 3, line 63 to column 5, line 46) many of the components used in electrophoretic displays, and the methods used to manufacture such displays, are derived from technology used in liquid crystal displays (LCD's). For example, electrophoretic displays may make use of an active matrix backplane comprising an array of transistors or diodes and a corresponding array of pixel electrodes, and a “continuous” front electrode (in the sense of an electrode which extends over multiple pixels and typically the whole display) on a transparent substrate, these components being essentially the same as in LCD's. However, the methods used for assembling LCD's cannot be used with encapsulated electrophoretic displays. LCD's are normally assembled by forming the backplane and front electrode on separate glass substrates, then adhesively securing these components together leaving a small aperture between them, placing the resultant assembly under vacuum, and immersing the assembly in a bath of the liquid crystal, so that the liquid crystal flows through the aperture between the backplane and the front electrode. Finally, with the liquid crystal in place, the aperture is sealed to provide the final display.

This LCD assembly process cannot readily be transferred to encapsulated displays. Because the electrophoretic material is solid, it must be present between the backplane and the front electrode before these two integers are secured to each other. Furthermore, in contrast to a liquid crystal material, which is simply placed between the front electrode and the backplane without being attached to either, an encapsulated electrophoretic medium normally needs to be secured to both; in most cases the electrophoretic medium is formed on the front electrode, since this is generally easier than forming the medium on the circuitry-containing backplane, and the front electrode/electrophoretic medium combination is then laminated to the backplane, typically by covering the entire surface of the electrophoretic medium with an adhesive and laminating under heat, pressure and possibly vacuum. Accordingly, most prior art methods for final lamination of solid electrophoretic displays are essentially batch methods in which (typically) the electro-optic medium, a lamination adhesive and a backplane are brought together immediately prior to final assembly, and it is desirable to provide methods better adapted for mass production.

Electro-optic displays, including electrophoretic displays, can be costly; for example, the cost of the color LCD found in a portable computer is typically a substantial fraction of the entire cost of the computer. As the use of such displays spreads to devices, such as cellular telephones and personal digital assistants (PDA's), much less costly than portable computers, there is great pressure to reduce the costs of such displays. The ability to form layers of electrophoretic media by printing techniques on flexible substrates, as discussed above, opens up the possibility of reducing the cost of electrophoretic components of displays by using mass production techniques such as roll-to-roll coating using commercial equipment used for the production of coated papers, polymeric films and similar media.

An electro-optic display normally comprises a layer of electro-optic material and at least two other layers disposed on opposed sides of the electro-optic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode and the other electrode layer is patterned into a matrix of pixel electrodes, each of which defines one pixel of the display. In another type of electro-optic display, which is intended for use with a stylus, print head or similar movable electrode separate from the display, only one of the layers adjacent the electro-optic layer comprises an electrode, the layer on the opposed side of the electro-optic layer typically being a protective layer intended to prevent the movable electrode damaging the electro-optic layer.

The aforementioned U.S. Pat. No. 6,982,178 describes a method of assembling a solid electro-optic display (including an encapsulated electrophoretic display) which is well adapted for mass production. Essentially, this patent describes a so-called “front plane laminate” (“FPL”) which comprises, in order, a light-transmissive electrically-conductive layer (a first electrode layer); a layer of a solid electro-optic medium in electrical contact with the electrically-conductive layer; an adhesive layer; and a release sheet. Typically, the light-transmissive electrically-conductive layer will be carried on a light-transmissive substrate, which is preferably flexible, in the sense that the substrate can be manually wrapped around a drum (say) 10 inches (254 mm) in diameter without permanent deformation. The term “light-transmissive” is used in this patent and herein to mean that the layer thus designated transmits sufficient light to enable an observer, looking through that layer, to observe the change in display states of the electro-optic medium, which will normally be viewed through the electrically-conductive layer and adjacent substrate (if present); in cases where the electro-optic medium displays a change in reflectivity at non-visible wavelengths, the term “light-transmissive” should of course be interpreted to refer to transmission of the relevant non-visible wavelengths. The substrate will typically be a polymeric film and will normally have a thickness in the range of about 1 to about 25 mil (25 to 634 μm), preferably about 2 to about 10 mil (51 to 254 μm). The electrically-conductive layer is conveniently a thin metal or metal oxide layer of, for example, aluminum or ITO, or may be a conductive polymer. Poly(ethylene terephthalate) (PET) films coated with aluminum or ITO are available commercially, for example as “aluminized Mylar” (“Mylar” is a Registered Trademark) from E.I. du Pont de Nemours & Company, Wilmington DE, and such commercial materials may be used with good results in the front plane laminate.

Assembly of an electro-optic display using such a front plane laminate may be effected by removing the release sheet from the front plane laminate and contacting the adhesive layer with the backplane under conditions effective to cause the adhesive layer to adhere to the backplane, thereby securing the adhesive layer, layer of electro-optic medium and electrically-conductive layer to the backplane. This process is well-adapted to mass production since the front plane laminate may be mass produced, typically using roll-to-roll coating techniques, and then cut into pieces of any size needed for use with specific backplanes.

U.S. Pat. No. 7,561,324 describes a so-called “double release sheet” which is essentially a simplified version of the front plane laminate of the aforementioned U.S. Pat. No. 6,982,178. One form of the double release sheet comprises a layer of a solid electro-optic medium sandwiched between two adhesive layers, one or both of the adhesive layers being covered by a release sheet. Another form of the double release sheet comprises a layer of a solid electro-optic medium sandwiched between two release sheets. Both forms of the double release film are intended for use in a process generally similar to the process for assembling an electro-optic display from a front plane laminate already described, but involving two separate laminations; typically, in a first lamination the double release sheet is laminated to a front electrode to form a front sub-assembly, and then in a second lamination the front sub-assembly is laminated to a backplane to form the final display, although the order of these two laminations could be reversed if desired.

U.S. Pat. No. 7,839,564 describes a so-called “inverted front plane laminate”, which is a variant of the front plane laminate described in the aforementioned U.S. Pat. No. 6,982,178. This inverted front plane laminate comprises, in order, at least one of a light-transmissive protective layer and a light-transmissive electrically-conductive layer; an adhesive layer; a layer of a solid electro-optic medium; and a release sheet. This inverted front plane laminate is used to form an electro-optic display having a layer of lamination adhesive between the electro-optic layer and the front electrode or front substrate; a second, typically thin layer of adhesive may or may not be present between the electro-optic layer and a backplane. Such electro-optic displays can combine good resolution with good low temperature performance.

A full color display may be provided by using an electrophoretic media containing multiple colored pigment particles having varying electrophoretic mobility. For example, U.S. Pat. No. 9,921,451 teaches a colored electrophoretic display that includes an electrophoretic medium which comprises (a) one type of light-scattering pigment particles (typically white) and (b) three substantially non-light-scattering types of pigment particles providing three subtractive primary colors. The use of substantially non-light-scattering particle types having subtractive primary colors allows mixing of colors and provides for more color outcomes at a single pixel than can be achieved with a color filter. Electrophoretic media and electrophoretic devices display complex behaviors, particularly those containing multiple set of charged pigments with varying charges and mobility. Complicated “waveforms” are needed to drive the particles between states. Compounded with the complexities of the electric fields, the mixture of particles and fluid can exhibit unexpected behavior because of the interactions between charged pigment particles, charge control agent molecules, the suspending liquid, and the encapsulating materials upon the application of an electric field. In general, it is difficult to predict how an electrophoretic display will respond to variations in the electrophoretic medium composition. Generally, when an electrophoretic medium composition is modified by changing the chemical nature or the content of the charge control agent, the charge of all types of pigment particles s typically change without exception. For example, in an electrophoretic medium that includes multiple types of charged pigment particles, the zeta potential of all of the types of charged pigment particles are modified by a change in the charge control agent type. If a modification of the zeta potential of only one type of charge pigment particles is desired, it is typically necessary to modify the specific type of charge pigment particle itself, usually by preparing a new pigment particle. Thus, it would be beneficial to be able to develop ways to control the zeta potential of a single type of charged pigment particles without significantly affecting the zeta potential of other types of charged pigment particles in the same electrophoretic medium. The inventor of the present invention surprisingly found that by using a polymeric charge control agent in an electrophoretic medium, the electrophoretic medium comprising a charge control agent containing a quaternary ammonium salt head or an imidazolium cation head, a hydrophobic tail, and a counter ion, the counter ion being an anion, the anion being a conjugate base of an acid having pKa of less than or equal to −2.5, the polymeric charge control agent modified the zeta potential of one type of charged pigment particles without significantly modifying the zeta potential of other types of charged pigment particles. Furthermore, The inventor of the present invention surprisingly found that by using an electrophoretic medium comprising a plurality of charged pigment particles, a non-polar liquid, and a polymeric charge control agent that contains a quaternary ammonium salt head or an imidazolium cation head, a hydrophobic tail, and a counter ion that is an anion, the anion being a conjugate base of an acid having pKa of less than or equal to −2.5, the corresponding electro-optic display provided a broader color gamut compared to an electro-optic display comprising similar electrophoretic medium containing a charge control agent with similar molecular structure but having a different counter ion.

### SUMMARY OF THE INVENTION

In one aspect, the present invention provides an electrophoretic medium comprising a plurality of charged particles, a charge control agent, and a non-polar liquid. The plurality of charged particles are capable of moving through the non-polar liquid upon application of an electric field. The charge control agent has a molecular structure comprising a quaternary ammonium functional group or an imidazolium cation, a hydrophobic tail, and a counter ion. The counter ion of the charge control agent is an anion, the anion being a conjugate base of an acid, the acid having a pKa of less than or equal to −2.5, or from −2.5 to −16. The counter ion of the charge control agent may be selected from the group consisting of trifluoromethanesulfonate, bis(trifluoromethane) sulfonimide, sulfate, perchlorate, chloride, bromide and iodide.

The charge control agent may be a molecule selected from the group consisting of a branched polyethylenimine derivative, a molecule that is represented by Formula I, a molecule that is represented by Formula II, a molecule that is represented by Formula III, a molecule that is represented by Formula IV, and a molecule that is represented by Formula V.

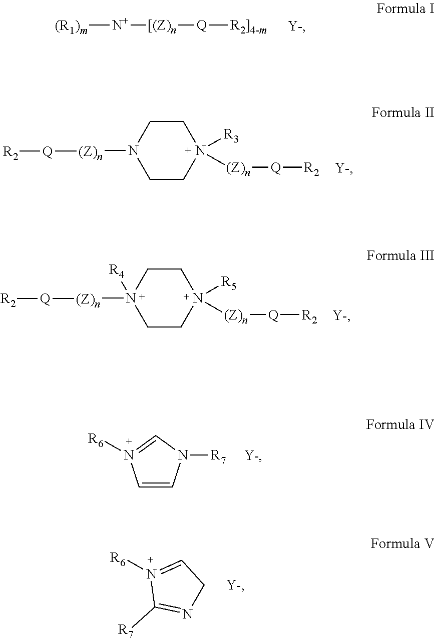

The branched polyethylenimine derivative has a molecular structure comprising one or more quaternary ammonium functional groups and one or more hydrophobic moieties. R₁ is independently selected from the group consisting of an aryl group and an alkyl group, the alkyl group having from 1 to 10 carbon atoms; m is an integer from 0 to 3; Z is one of a branched or nonbranched alkanediyl group; n is an integer from 3 to 20; Q is a moiety selected from the group consisting of an ester, a thioester, an amide, an imide, a urea, and a carbamate; R₂ is a hydrophobic moiety; R₃, R₄, and R₅, are selected from the group consisting of an alkyl group having from 1 to 20 carbon atoms and an aryl group; each R₆, and R₇ are independently selected from the group consisting of an alkyl group having from 1 to 20 carbon atoms, an aryl group, and —(Z)ₙ-Q-R₂, and at least one of R₆ and R₇ is —(Z)ₙ-Q-R₂; and Y— is the counter ion.

The hydrophobic moiety of the branched polyethylenimine derivative and the hydrophobic moiety R₂ of Formulas I to V may be selected from an alkyl group, an alkenyl group, a polyester, a polyether, a polyamide, a polyurethane, a polyurea, a polyacrylate, a methacrylate, a polydimethylsiloxane, and combinations thereof. The hydrophobic moiety R₂ of Formulas I to V may have from 50 to 1000 carbon atoms or from 10 to 300 dimethylsiloxane groups. The hydrophobic moiety of the branched polyethylenimine derivative and the hydrophobic moiety R₂ of Formulas I to V may be derived from a monomer selected from the group consisting of ricinoleic acid, isobutylene, hydroxystearic acid, and combinations thereof.

The charge control agent that is a molecule represented by Formulas I to Formula V may have a weight average molecular weight of from 800 g/mol to 12,000 g/mol. The charge control agent that is a molecule represented by Formulas I to Formula V may have a weight average molecular weight greater or equal to 1,000 g/mol.

In the case where the charge control agent is a branched polyethylenimine derivative, the branched polyethylenimine derivative may have more than one hydrophobic moieties and more than one quaternary ammonium functional groups. The branched polyethylenimine derivative may be formed from a branched polyethylenimine having primary, secondary, and tertiary amino functional groups. The more than one hydrophobic moieties of the branched polyethylenimine derivative may be formed by a reaction of primary and/or secondary amine groups of the branched polyethylenimine with a monomer selected from the group consisting of ricinoleic acid, isobutylene, hydroxystearic acid, and combinations thereof. The more than one quaternary ammonium functional groups of the branched polyethylenimine derivative may be formed by alkylation reaction of tertiary amino functional groups of the branched polyethylenimine. The counter ion of the quaternary ammonium functional group of the branched polyethylenimine derivative may be selected from the group consisting of trifluoromethanesulfonate, bis(trifluoromethane)sulfonamide, sulfate, perchlorate, chloride, bromide and iodide. The number average molecular weight of the branched polyethylenimine derivative may be higher than 1,000 g/mole.

The charge control agent may be a molecule that is represented by Formula VI or Formula VII. Each R₈, R₉, R₁₀ is independently selected from the group consisting of an alkyl group, the alkyl group having from 1 to 10 carbon atoms; o is an integer from 3 to 10.

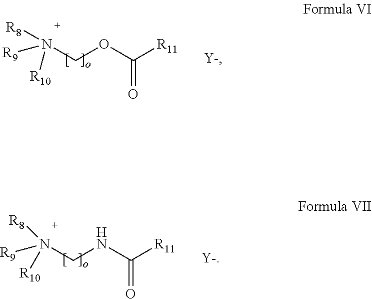

Rn is a hydrophobic moiety. The hydrophobic moiety may be selected from an alkyl group, an alkenyl group, a polyester, a polyether, a polyamide, a polyurethane, a polyurea, a polyacrylate, a methacrylate, a polydimethylsiloxane, and combinations thereof. The counter ion Y— may be selected from the group consisting of trifluoromethanesulfonate, bis(trifluoromethane)sulfonamide, sulfate, perchlorate, chloride, bromide and iodide. Groups R₈, R₉, R₁₀ of Formula VI of Formula VII may be methyl groups and the hydrophobic moiety R₁₁ may comprise a functional group selected from the group consisting of poly(hydroxystearic acid), poly(ricinoleic acid), and poly(isobutylene) and the counter ion Y— may be selected from the group consisting of trifluoromethanesulfonate, bis(trifluoromethane)sulfonamide, sulfate, perchlorate, chloride, bromide and iodide.

The charge control agent may be a molecule represented by Formula VIII or Formula IX.

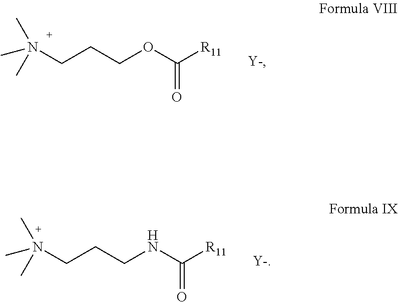

Group R₁₁ may be a hydrophobic moiety comprising a functional group selected from the group consisting of poly(hydroxystearic acid), poly(ricinoleic acid), and poly(isobutylene). Counter ion Y— may be trifluoromethanesulfonate, bis(trifluoromethane)sulfonamide, sulfate, perchlorate, chloride, bromide or iodide.

The charge control agent may be a molecule that is represented by Formula X or Formula XI.

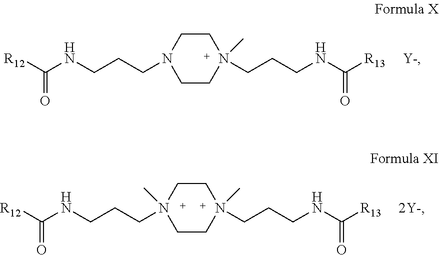

Groups R₁₂ and R₁₃ may be hydrophobic moieties comprising a functional group selected from the group consisting of poly(hydroxystearic acid), poly(ricinoleic acid), and poly(isobutylene). Counter ion Y— may be trifluoromethanesulfonate, bis(trifluoromethane)sulfonamide, sulfate, perchlorate, chloride, bromide or iodide.

The charge control agent may be a molecule that is represented by Formula XII.

Group R₁₄ may be alkyl group, the alkyl group having from 1 to 10 carbon atoms. Group R₁₅ may be a hydrophobic moiety comprising a functional group selected from the group consisting of poly(hydroxystearic acid), poly(ricinoleic acid), and poly(isobutylene). Counter ion Y— may be trifluoromethanesulfonate, bis(trifluoromethane)sulfonamide, sulfate, perchlorate, chloride, bromide or iodide.

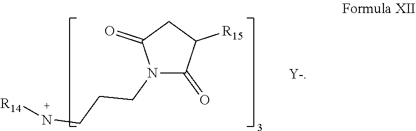

The charge control agent may be a molecule that is represented by Formula XIII. Each R₁₆, R₁₇, R₁₈ may be independently selected from the group consisting of an alkyl group, the alkyl group having from 1 to 10 carbon atoms. Group R₁₉ may be a hydrophobic moiety comprising a functional group selected from the group consisting of poly(hydroxystearic acid), poly(ricinoleic acid), and poly(isobutylene). Counter ion Y— may be trifluoromethanesulfonate, bis(trifluoromethane)sulfonamide, sulfate, perchlorate, chloride, bromide or iodide. Groups Each R₁₆, R₁₇, R₁₈ may be methyl, ethyl, or phenyl and counter ion Y— may be trifluoromethanesulfonate.

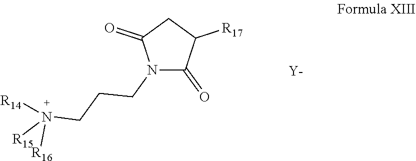

The electrophoretic medium of the present invention may further comprise a second charge control agent. The second charge control agent may comprise a hydrophobic moiety and a head group, the head group being selected from the group comprising an anionic functional group, a nonionic functional group, and a cationic functional group. The second charge control agent may comprise an ammonium cation, an acyclic secondary amide group, and a hydrophobic moiety.

In another aspect, the present invention provides an electro-optic display comprising a first electrode layer, an electro-optic material layer, and a second electrode layer. The electro-optic material layer is disposed between the first electrode layer and the second electrode layer. The first electrode layer is light transmissive. The second electrode layer comprises a plurality of pixel electrodes. The electro-optic material layer comprises a plurality of microcapsules or a plurality of microcells. The first electrode layer and the second electrode layer are configured to apply an electric field across the electro-optic material layer. Each microcapsule or microcell comprises an electrophoretic medium. The electrophoretic medium comprises a plurality of charged particles, a charge control agent, and a non-polar liquid. The plurality of charged particles are capable of moving through the non-polar liquid upon application of an electric field. The charge control agent has a molecular structure comprising a quaternary ammonium functional group or an imidazolium cation, a hydrophobic tail, and a counter ion. The counter ion of the charge control agent is an anion, the anion being a conjugate base of an acid, the acid having a pKa of less than or equal to −2.5, or from −2.5 to −16. The counter ion of the charge control agent may be selected from the group consisting of trifluoromethanesulfonate, bis(trifluoromethane) sulfonimide, sulfate, perchlorate, chloride, bromide and iodide. The charge control agent may be a molecule selected from a group consisting of a branched polyethylenimine derivative, a molecule that is represented by Formula I, a molecule that is represented by Formula II, a molecule that is represented by Formula III, a molecule that is represented by Formula IV, and a molecule that is represented by Formula V. The branched polyethylenimine derivative has a molecular structure comprising one or more quaternary ammonium functional group and one or more hydrophobic moieties. R₁ is independently selected from the group consisting of aryl group and an alkyl group, the alkyl group having from 1 to 10 carbon atoms; m is an integer from 0 to 3; Z is one of a branched or nonbranched alkanediyl group; n is an integer from 3 to 20; Q is a moiety selected from the group consisting of an ester, a thioester, an amide, an imide, a urea, and a carbamate; R₂ is a hydrophobic moiety; R₃, R₄, and R₅, are selected from the group consisting of an alkyl group having from 1 to 20 carbon atoms and an aryl group; each R₆, and R₇ are independently selected from the group consisting of an alkyl group having from 1 to 20 carbon atoms, an aryl group, and —(Z)ₙ-Q-R₂, and at least one of R₆, and R₇ is —(Z)ₙ-Q-R₂; and Y— is the counter ion. The hydrophobic moiety of the branched polyethylenimine derivative and the hydrophobic moiety R₂ of Formulas I to V may be selected from an alkyl group, an alkenyl group, a polyester, a polyether, a polyamide, a polyurethane, a polyurea, a polyacrylate, a methacrylate, a polydimethylsiloxane, and combinations thereof. The hydrophobic moiety R₂ of Formulas I to V may have from 50 to 1000 carbon atoms or from 10 to 300 dimethylsiloxane groups. The hydrophobic moiety of the branched polyethylenimine derivative and the hydrophobic moiety R₂ of Formulas I to V may be derived from a monomer selected from the group consisting of ricinoleic acid, isobutylene, hydroxystearic acid, and combinations thereof. The charge control agent that is a molecule represented by Formulas I to Formula V may have a weight average molecular weight of from 800 g/mol to 12,000 g/mol. The charge control agent that is a molecule represented by Formulas I to Formula V may have a weight average molecular weight greater or equal to 1,000 g/mol.

In the case of electro-optic devices comprising a plurality of microcells, each of the plurality of microcells includes a bottom layer, partition walls, an opening, and a scaling layer, the sealing layer spanning the opening of each microcell.

In the case of electro-optic devices comprising a plurality of microcapsules, the electro-optic material layer may comprise the plurality of microcapsules and a binder.

### BRIEF DESCRIPTION OF DRAWINGS

FIG. 1 is a side view of a color electro-optic display comprising electrophoretic medium encapsulated in microcapsules. The color electrophoretic display comprises, in order, a first electrode layer, an electro-optic material layer, a first adhesive layer, and a second electrode layer.

FIG. 2 is a side view of a color electro-optic display comprising electrophoretic medium encapsulated in microcapsules. The color electrophoretic display comprises, in order, a first electrode layer, a second adhesive layer, an electro-optic material layer, a first adhesive layer, and a second electrode layer.

FIG. 3 is a side view of a color electro-optic display comprising electrophoretic medium encapsulated in microcells. The color electrophoretic display comprises, in order, a first electrode layer, an electro-optic material layer including a sealing layer, a first adhesive layer, and a second electrode layer.

FIG. 4 is an illustration of a methylation reaction of a cationic charge control agent comprising a methyl sulfate counter ion.

FIG. 5 is an illustration of a methylation reaction of a cationic charge control agent comprising a trifluoromethanesulfonate counter ion.

FIG. 6 is a graph of maximum zeta potential of various charged particles in various electrophoretic compositions.

FIG. 7 shows the color gamut of inventive and comparative electrophoretic compositions at 0° C.

FIG. 8 shows the color gamut of inventive and comparative electrophoretic compositions at 25° C.

FIG. 9 shows the color gamut of inventive and comparative electrophoretic compositions at 50° C.

### DETAILED DESCRIPTION OF THE INVENTION

In the following detailed description, numerous specific details are set forth by way of examples in order to provide a thorough understanding of the relevant teachings. However, it should be apparent to those skilled in the art that the present teachings may be practiced without such details.

The present invention provides electrophoretic media comprising pigment particles and a charge control agent. A particle that absorbs, scatters, or reflects light, either in a broad band or at selected wavelengths, is referred to herein as a pigment particle. The electrophoretic media may be incorporated into displays or into front plane laminates or inverted front plane laminates, front plane laminates and inverted front plane laminates being coupled to a backplane to form a display.

As used herein, “head group” of a molecule, the molecule comprising both a hydrophilic and hydrophobic part, is the functional group of the hydrophilic part of the molecule. The molecule may have one head group or more than one head groups. The hydrophobic part of the molecule is also called “tail”.

The term “molecular weight” or “MW” as used herein refers to the weight average molecular weight, unless otherwise stated. The weight average molecular weight is measured by gel permeation chromatography.

As used herein, the term pKa of a material is the negative logarithm of the acid dissociation constant (Ka) of the material in an aqueous solution at 25° C. The smaller the value of pKa, the stronger the acid. The values of pKa of acids can be found in the literature as measured or predicted. Negative pKa means that the corresponding acid is very strong. It is well established in chemistry that a conjugate base of a strong acid is a weak base.

A surface of particles that comprises a metal oxide, such as titanium oxide, aluminum oxide, zirconium oxide, etc., or silica is typically acidic, because it includes functional groups having O—H bond. The typical pKa of such particles in an aqueous medium has a value of 2 to 6. On the contrary, organic pigment particles, which do not contain a metal oxide or silica on their surface, have a surface that is less acidic (or neutral or basic) with pKa of higher than 6. The pKa of particles in an aqueous medium can be determined by potentiometric titration of an aqueous dispersion of the particles using alkali solution titrant or acidic solution titrant. A relevant example of pKa determination is described in U.S. Pat. No. 10,078,285 B2.

The electrophoretic media according to the various embodiments of the present invention comprises a plurality of charged particles, a charge control agent, and a non-polar liquid. The charge control agent has a molecular structure comprising a quaternary ammonium functional group or an imidazolium cation, a hydrophobic tail, and a counter ion. The counter ion of the charge control agent is an anion, the ion being a conjugate base of an acid, the acid having a pKa of less than or equal to −2.5. The acid may have a pKa of from −2.5 to −16, from −2.5 to −10, or from −2.5 to −5. The counter ion of the quaternary ammonium functional group or the counterion of the imidazolium cation may be selected from the group consisting of trifluoromethanesulfonate, bis(trifluoromethane)sulfonamide, sulfate, perchlorate, chloride, bromide and iodide.

The charge control agent may be a molecule that is represented by Formula I, Formula II, Formula III, Formula IV, or Formula V.

R₁ groups of Formula I are independently selected from the group consisting of an alkyl group having from 1 to 10 carbon atoms, and an aryl group; m is an integer from 0 to 3; R₂ is a hydrophobic moiety. The hydrophobic moiety R₂ may be selected from a group consisting of an alkyl group, an alkenyl group, a polyester, a polyether, a polyamide, a polyurethane, a polyurea, a polyacrylate, a methacrylate, a polydimethylsiloxane, and combinations thereof; Z is one of a branched or nonbranched alkanediyl group; n is an integer from 3 to 20; Q is a moiety selected from the group consisting of an ester, a thioester, an amide, an imide, a urea, and a carbamate; the ester, the thioester, the amide, the imide, the urea, and the carbamate may be part of a moiety that comprises a ring structure or may be part of a moiety that does not comprise a ring structure. The number of atoms of the ring structure may be from 4 to 8, from 5 to 7, or from 5 to 6.

Group R₃ of Formula II and R₄, and R₅ of Formula III may be selected from the group consisting of an alkyl group having from 1 to 20 carbon atoms and an aryl group. Each R₆, and R₇ of Formula IV and Formula V are independently selected from the group consisting of an alkyl group having from 1 to 20 carbon atoms, an aryl group, and —(Z)ₙ-Q-R₂, at least one of R₆, and R₇ is —(Z)ₙ-Q-R₂, and Y— is the counter ion.

Groups R₁ of Formula I may be methyl, ethyl, propyl, phenyl or benzyl groups. If there are more than one alkyl groups connected to the amine atom of the quaternary ammonium group of Formula I, the alkyl groups may be the same or different. For example, Formula I may comprise a trimethylammonium cationic group, a triethylammonium cationic group, a dimethylethylammonium cation group, etc. Group (Z) n of Formula I (and Formulas II to V) may be —CH₂—, —CH₂CH₂—, —CH₂CH₂CH₂—, —CH₂CH₂CH₂CH₂—, etc. Group (Z), may be an unbranched group —(CH₂)_{q}— wherein q may be from 1 to 20. Alternatively, group (Z) n may be a branched alkanediyl group, such as —CH₂(CH₃)CH₂CH₂—. The Q moiety may represented by a variety of non-ionic, polar functional groups such as an ester group [—O—C(O)—], a thioester group [—S—C(O)—], a tertiary amide group [—N(alkyl)-C(O)—], a carbamate group [—NH—C(O)—O—] or [—O—C(O)—NH—], a urea group [—NH—C(O)—NH—], and combinations thereof. The ester group, the thioester group, the urea group, the tertiary amide group, the carbamate group, and the urea group may be part of a ring structure, or not part of a ring structure. The Q moiety may be represented by following succinimide structure of Formula XIV. In this case, the nitrogen is bonded to a carbon atom of the (Z) n group and one of the carbon atoms of the ring is bonded to an atom of the hydrophobic moiety R₂. In Formulas I to V.

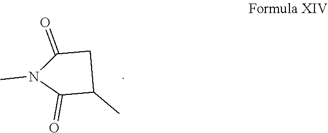

As shown in the charge control agents that are represented by Formulas I and V, the charge control agents used in the various embodiments of the present invention are not limited to mono-quaternary ammonium materials or material comprising only one imidazolium cation. The materials may include, for example, bis-quaternary ammonium salts, tris-quaternary ammonium salts, etc.

The charge control agent of the electrophoretic medium of the present invention may be a branched polyethylenimine derivative, the branched polyethylenimine derivative having one or more quaternary ammonium functional groups and one or more hydrophobic moieties. The branched polyethylenimine derivative may be formed by a branch polyethylenimine, the branch polyethylenimine having primary, secondary, and tertiary amino groups. The number average molecular weight of the branched polyethylenimine derivative may be higher than 1,000 g/mole.

The hydrophobic moiety of the branched polyethylenimine derivative may be selected from a group consisting of an alkyl group, an alkenyl group, a polyester, a polyether, a polyamide, a polyurethane, a polyurea, a polyacrylate, a methacrylate, a polydimethylsiloxane, and combinations thereof. The hydrophobic moiety of the branched polyethylenimine derivative may be formed by a reaction of a primary or secondary amino group of the branched polyethylenimine with a monomer or an oligomer. The monomer may be selected from the group consisting of ricinoleic acid, isobutylene, hydroxystearic acid, and combinations thereof.

The quaternary ammonium functional group of the branched polyethylenimine derivative may be formed from an alkylation reaction between a tertiary amino group of a branched polyethylenimine and an alkylating reagent.

The counter ion of the quaternary ammonium functional groups of the branched polyethylenimine derivative may be selected from the group consisting of trifluoromethanesulfonate, bis(trifluoromethane)sulfonamide, sulfate, perchlorate, chloride, bromide and iodide.

The charge control agent of the electrophoretic medium of the present invention may be represented by Formula VI or Formula VII. Each of groups R₈, R₉, R₁₀ of Formulas VI and VII are independently selected from the group consisting of an alkyl group, the alkyl group having from 1 to 10 carbon atoms. The variable o is an integer from 3 to 20, or from 3 to 10. Group R₁₁ is a hydrophobic moiety, the hydrophobic moiety being selected from an alkyl group, an alkenyl group, a polyester, a polyether, a polyamide, a polyurethane, a polyurea, a polyacrylate, a methacrylate, a polydimethylsiloxane, and combinations thereof. The hydrophobic moiety R₁₁ may comprise a functional group selected from the group consisting of poly(hydroxystearic acid), poly(ricinoleic acid), and poly(isobutylene). The counter ion of the molecules represented by Formulas VI and VII may be trifluoromethanesulfonate. The counter ion may also be bis(trifluoromethane)sulfonamide, sulfate, perchlorate, chloride, bromide and iodide.

The charge control agent of the electrophoretic medium of the present invention may be represented by Formulas VIII and IX. In these molecules, the nitrogen of the quaternary ammonium functional group is bonded to three methyl groups. Group R₁₁ is a hydrophobic moiety, the hydrophobic moiety being selected from an alkyl group, an alkenyl group, a polyester, a polyether, a polyamide, a polyurethane, a polyurea, a polyacrylate, a methacrylate, a polydimethylsiloxane, and combinations thereof. The hydrophobic moiety R₁₁ may comprise a functional group selected from the group consisting of poly(hydroxystearic acid), poly(ricinoleic acid), and poly(isobutylene). The counter ion of the molecules represented by Formulas VIII and XI may be trifluoromethanesulfonate. The counter ion may also be bis(trifluoromethane)sulfonamide, sulfate, perchlorate, chloride, bromide and iodide.

The charge control agent of the electrophoretic medium of the present invention may be a molecule that is represented by Formulas X or XI. In Formula X the nitrogen of quaternary ammonium functional group is part of a six-member ring and it also bonded to a methyl group. In Formula XI, there are two quaternary ammonium functional groups, the nitrogen of which are part of a six-member group and the are also bonded to methyl groups. Groups R₁₁ and R₁₂ may be independently selected. Groups R₁₁ and R₁₂ are hydrophobic moieties, the hydrophobic moieties being selected from an alkyl group, an alkenyl group, a polyester, a polyether, a polyamide, a polyurethane, a polyurea, a polyacrylate, a methacrylate, a polydimethylsiloxane, and combinations thereof. The hydrophobic moieties R₁₁ and R₁₂ may comprise a functional group selected from the group consisting of poly(hydroxystearic acid), poly(ricinoleic acid), and poly(isobutylene). The counter ion of the molecules represented by Formulas X and XI may be trifluoromethanesulfonate. The counter ion may also be bis(trifluoromethane)sulfonamide, sulfate, perchlorate, chloride, bromide and iodide.

The charge control agent of the electrophoretic medium of the present invention may be a molecule that is represented by Formula XII. In this case, the molecule comprises a substituted succinimide, which is bonded to a hydrophobic moiety (R₁₅). The molecule comprises a quaternary ammonium functional group. The nitrogen of the quaternary ammonium functional group is bonded to group R₁₄, which is an alkyl group having from 1 to 20 carbon atoms, or from 1 to 10 carbon atoms. Hydrophobic moiety R₁₅ may be selected from an alkyl group, an alkenyl group, a polyester, a polyether, a polyamide, a polyurethane, a polyurea, a polyacrylate, a methacrylate, a polydimethylsiloxane, and combinations thereof. Hydrophobic moiety R₁₅ may comprise a functional group selected from the group consisting of poly(hydroxystearic acid), poly(ricinoleic acid), and poly(isobutylene). The counter ion of the molecule represented by Formula XII may be trifluoromethanesulfonate. The counter ion may also be bis(trifluoromethane)sulfonamide, sulfate, perchlorate, chloride, bromide and iodide.

The charge control agent of the electrophoretic medium of the present invention may be a molecules that may be represented by Formula XIII. In this case, the molecule comprises a substituted succinimide, which is bonded to a hydrophobic moiety (R₁₉). The molecule comprises a quaternary ammonium functional group. The nitrogen of the quaternary ammonium functional group is bonded to groups R₁₆, R₁₇, and R₁₈. Each of groups R₁₆, R₁₇, and R₁₈ of Formula XII is independently selected from the group consisting of an alkyl group, the alkyl group having from 1 to 20 carbon atoms, or 1 to 10 carbon atoms. Groups R₁₆, R₁₇, and R₁₈ of Formula XII may be methyl or ethyl groups. Hydrophobic moiety R₁₉ may be selected from an alkyl group, an alkenyl group, a polyester, a polyether, a polyamide, a polyurethane, a polyurea, a polyacrylate, a methacrylate, a polydimethylsiloxane, and combinations thereof. Hydrophobic moiety R₁₉ may comprise a functional group selected from the group consisting of poly(hydroxystearic acid), poly(ricinoleic acid), and poly(isobutylene). The counter ion of the molecule represented by Formula XIII may be trifluoromethanesulfonate. The counter ion may also be bis(trifluoromethane)sulfonamide, sulfate, perchlorate, chloride, bromide and iodide.

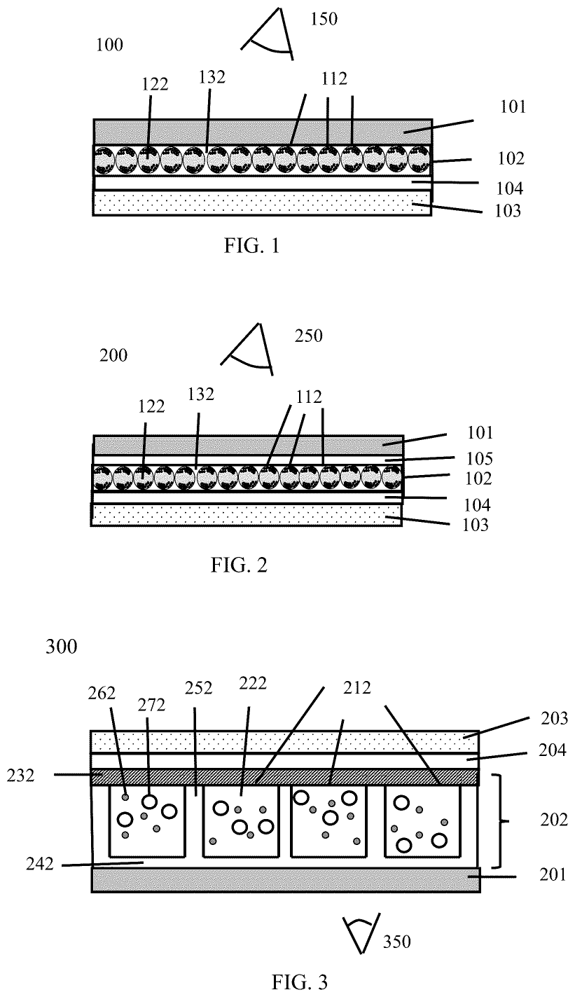

A typical color electro-optic display may have an electro-optic material layer that comprises an electrophoretic medium, which is encapsulated in microcapsules or microcells, as described in U.S. Pat. No. 6,982,178. FIG. 1 shows a side view of an example of a portion of a color electro-optic display having microcapsules. Color electro-optic display 100 comprises a first electrode layer 101 comprising a light transmissive electrode, an electro-optic material layer 102, a first adhesive layer 104, and a second electrode layer 103, the second electrode layer comprising a plurality of pixel electrodes. The first adhesive layer 104 connects the electro-optic material layer 102 with the second electrode layer. The electro-optic material layer 102 comprises a plurality of microcapsules 112. Each microcapsule has a microcapsule wall and includes electrophoretic medium 122 having charge pigment particles and a charge control agent in a non-polar liquid. Electrophoretic medium 122 comprises a plurality of first type of charged pigment particles and a plurality of second type of pigment particles. Electrophoretic medium may further comprise a plurality of third type of charged pigment particles. Electrophoretic medium 122 may further comprise a plurality of fourth type of charged pigment particles. Electrophoretic medium 122 may further comprise a plurality of fifth type of charged pigment particles. Typically, the plurality of microcapsules are retained within a polymeric binder 132. A viewer can view the image of display 100 from the viewing side 150. At least one type of charged pigment particles may comprise an organic pigment. The color electro-optic material layer 100 may be constructed from a front plane laminate, as described in the background of the invention.

Another example of a color electro-optic display is shown in FIG. 2. FIG. 2 illustrates a side view of an example of the basic structure of a portion of a color electro-optic display having microcapsules. Electro-optic display 200 has a viewing side 150. It comprises, in order, a first electrode layer 101 comprising a light transmissive electrode, a second adhesive layer 105, an electro-optic material layer 102, a first adhesive layer 104, and a second electrode layer 103, comprising a plurality of pixel electrodes. The second adhesive layer 105 connects first electrode layer 101 with electro-optic material layer 102. The first adhesive layer 104 connects the electro-optic material layer 102 with the second electrode layer. The electro-optic material layer 102 comprises a plurality of microcapsules 112. Each microcapsule has a microcapsule wall and includes electrophoretic medium 122 having charge pigment particles and a charge control agent in a non-polar liquid. Electrophoretic medium 122 comprises a plurality of first type of charged pigment particles and a plurality of second type of pigment particles. Electrophoretic medium may further comprise a plurality of third type of charged pigment particles. Electrophoretic medium 122 may further comprise a plurality of fourth type of charged pigment particles. Electrophoretic medium 122 may further comprise a plurality of fifth type of charged pigment particles. At least one type of charged pigment particles may comprise an organic pigment. Typically, the plurality of microcapsules are retained within a polymeric binder 132. A viewer can view the image of display 200 from the viewing side 250. The color electro-optic material layer 100 may be constructed from a front plane laminate, as described in the background of the invention.

The microcapsule color electro-optic displays of FIGS. 1 and 2 may further comprise a light transmissive front substrate (not shown in FIGS. 1 and 2), which is adjacent to the first electrode layer 101, wherein the electrode layer is disposed between the front substrate and the electro-optic material layer (for the display of FIG. 1) or between the front substrate and the second adhesive layer (for the display of FIG. 1). The front substrate may be a plastic film, such as a sheet of poly(ethylene terephthalate) (PET) having thickness of from 25 to 200 μm. Front substrate may further comprise one or more additional layers, for example, a protective layer to absorb ultraviolet radiation, barrier layers to prevent ingress of oxygen or moisture into the display, and anti-reflection coatings to improve the optical properties of the display.

An example of a color electro-optic display that comprises microcells is illustrated in FIG. 3. Color electro-optic display 300 of FIG. 3 comprises, in order, a first electrode layer 201, an electro-optic material layer 202, an adhesive layer 204, and a second electrode layer 203, which comprises a plurality of pixel electrodes. Adhesive layer 204 connects sealing layer 232 of the electro-optic material layer 202 with second electrode layer 203 Electro-optic material layer 202 of color electro-optic display 300 comprises a plurality of microcells 212 and a sealing layer 232. Each microcell 212 of the plurality of microcells has a bottom 242, partition walls 252, and an opening, the sealing layer 232 spanning the opening of each microcell. Each microcell 212 of the plurality of microcells comprises electrophoretic medium 222. Electrophoretic medium 222 comprises a plurality of first type of charged pigment particles 272, a plurality of second type of charged pigment particles 262 and a charge control agent in a non-polar liquid. Electrophoretic medium 222 may further comprise a plurality of third type of charged pigment particles. Electrophoretic medium 222 may further comprise a plurality of fourth type of charged pigment particles. Electrophoretic medium 222 may further comprise a plurality of fifth type of charged pigment particles. At least one type of charged pigment particles may comprise an organic pigment. A viewer can view the image of display 300 from the viewing side 350. The color electro-optic material layer 300 may be constructed from a front plane laminate, as described in the background of the invention. The microcell color electro-optic displays of FIG. 3 may further comprise a light transmissive front substrate (not shown in FIG. 3), which is adjacent to the first electrode layer 201, wherein the electrode layer is disposed between the front substrate and the electro-optic material layer. The front substrate may be a plastic film, such as a sheet of poly(ethylene terephthalate) (PET) having thickness of from 25 to 200 μm. Front substrate may further comprise one or more additional layers, for example, a protective layer to absorb ultra violet radiation, barrier layers to prevent ingress of oxygen or moisture into the display, and anti-reflection coatings to improve the optical properties of the display.

The charge control agent of the electrophoretic medium of the lector-optic displays 100, 200, and 300 of FIGS. 1, 2, and 3 has a molecular structure comprising a quaternary ammonium functional group or an imidazolium cation, a hydrophobic tail, and a counter ion, the counter ion of the charge control agent being an anion, the anion being a conjugate base of an acid, the acid having a pKa of less than or equal to −2.5, or from −2.5 to −16. The charge control agent may be represented by Formulas I, II, III, IV, or V, with the limitations described above. The charge control agent may be a branched polyethylenimine derivative as described above. The charge control agent may also be a molecule that is represented by Formulas I to V, or by Formulas VI to XIII with the limitations described above.

In the electro-optic displays of FIGS. 1, 2, and 3, the first electrode layer may be a conductive layer having a thin continuous coating of electrically conductive material with minimal intrinsic absorption of electromagnetic radiation in the visible spectral range such as indium tin oxide (ITO), poly(3,4-ethylenedioxythiophene) poly(styrene sulfonate) (PEDOT:PSS), graphene or the like.

Microcells may be formed either in a batchwise process or in a continuous roll-to-roll process as disclosed in U.S. Pat. No. 6,933,098. The latter offers a continuous, low cost, high throughput manufacturing technology for production of compartments for use in a variety of applications including electro-optic display devices. Microcell arrays suitable for use with the invention can be created with microembossing.

### EXAMPLES

### Example of Preparation of Charge Control Agents

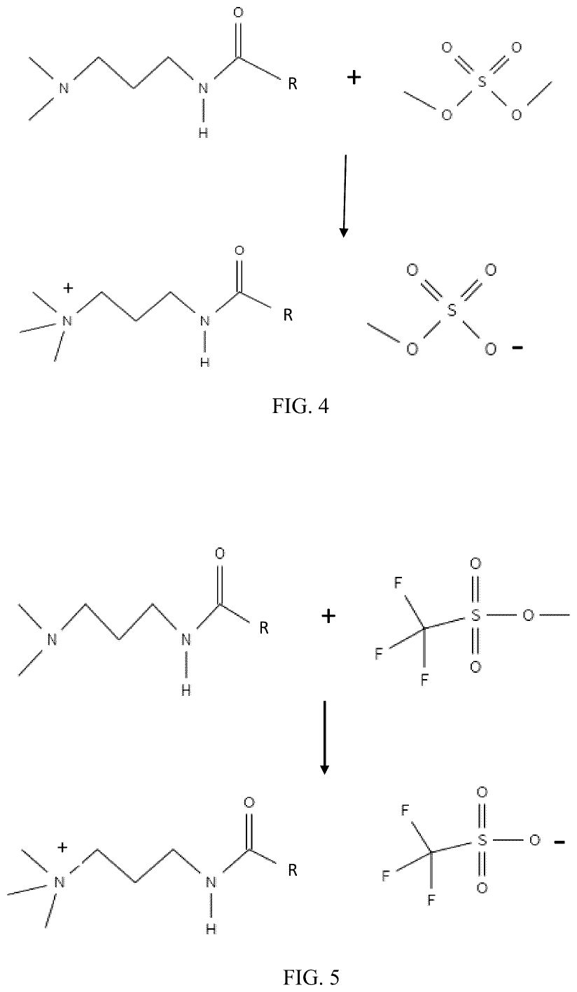

Comparative Example 1: Ricinoleic acid was mixed with 3-(dimethylamino)-1-propylamine and heated to 210° C. under nitrogen and with azeotropic removal of water using toluene. At the completion of the reaction, as determined by acid value titration, the reaction mixture was cooled to room temperature. Then, an alkylating agent, dimethyl sulfate (one equivalent of amine) was added and the methylation reaction was allowed to take place under ambient conditions for a period of at least 12 hours. At the completion of the reaction, the excess toluene was removed by vacuum distillation and the product was mixed with the designed solvent (e.g. Isopar E). The structure and preparation of Comparative Example 1 was described as CCA-111 in United States Application with Publication No. 2020/0355978. The methylation reaction is illustrated in FIG. 4, where R is poly(ricinoleic acid).

Example 2: The process of the Comparative Example 1 was repeated, replacing the dimethyl sulfate methylating reagent with methyl trifluoromethanesulfonate. The methylation reaction is illustrated in FIG. 5, where R is poly(ricinoleic acid).

### I. Example of Preparation of Pigment Particles Dispersions in Isopar E

Example 3: White pigment particles were prepared with a titanium dioxide pigment core, which comprises a polymer coating, as described in Example 1 of U.S. Pat. No. 8,582,196. The polymer coating comprising an approximately 95:5 molar ratio of lauryl methacrylate (LMA) and 2,2,2-trifluoroethyl methacrylate (TFEM).

Example 4: White pigment particles were prepared with a titanium dioxide pigment core, which comprises a polymer coating formed by lauryl methacrylate monomer.

Example 5: White pigment particles were prepared with a titanium dioxide pigment core, which comprises a polymer coating, as described in Example 1 of U.S. Pat. No. 8,582,196. The polymer coating comprising an approximately 99:1 molar ratio of lauryl methacrylate (LMA) and 2,2,2-trifluoroethyl methacrylate (TFEM).

Example 6: Cyan pigment particles were prepared with cyan copper phthalocyanine pigment (C.I. Pigment Blue 15:3), which comprises a polymer coating. The polymer coating was formed using methyl methacrylate monomer (MMA) and polysiloxane macromonomer (PDMS).

Example 7: Magenta pigment particles were prepared with magenta dimethylquinacridone pigment (C.I. Pigment Red 122), which comprises a polymer coating. The polymer coating was formed using vinylbenzyl chloride (VBC) and lauryl methyl methacrylate (LMA), as described in U.S. Pat. No. 9,697,778.

Example 8: A dispersion of yellow particles was prepared by milling Pigment Yellow 155, as generally described in U.S. Pat. No. 9,697,778.

All pigment particles were used as pigment particles dispersion in Isopar E. That is, (a) white pigment particles from Example 3 were used to make a white pigment dispersion in Isopar E, which corresponds to Example 3B; (b) white pigment particles from Example 4 were used to make a white pigment dispersion in Isopar E, which corresponds to Example 4B; (c) white pigment particles from Example 5 were used to make a white pigment dispersion in Isopar E, which corresponds to Example 5B (d) cyan pigment particles from Example 6 were used to make a cyan pigment dispersion in Isopar E, which corresponds to Example 6B (c) magenta pigment particles from Example 7 were used to make a magenta pigment dispersion in Isopar E, which corresponds to Example 7B; (f) yellow pigment particles from Example 8 were used to make a yellow pigment dispersion in Isopar E, which corresponds to Example 8B.

### II. Preparation of Electrophoretic Medium Having a Single Type of Pigment Particles

Example 10: A series of electrophoretic media were prepared using the white dispersion from Example 3B and charge control agent from Example 2. The various electrophoretic media comprised various amount of the charge control agent and the same amount of white pigment particles. The weight ratio of series of charge control agent (CCA) to white particles ranged from about 0.2 to about 150 mg of CCA per g of white pigment. The zeta potential of the pigment for each electrophoretic medium was determined and the maximum zeta potential was identified in the case of positive value of zeta potential or, in the case of a negative value of zeta potential, the minimum zeta potential was identified. In Example 10, the minimum zeta potential was identified as −11.2 eV.

Example 11: The procedure of Example 10 was repeated by preparing a series of electrophoretic media were prepared using the white dispersion from Example 4B and charge control agent from Example 2. In Example 11, the maximum zeta potential was 38.6 eV.

Example 12: The procedure of Example 10 was repeated by preparing a series of electrophoretic media were prepared using the white dispersion from Example 5B and charge control agent from Example 2. In Example 12, the maximum zeta potential was −20.6 eV.

Comparative Example 13: The procedure of Example 10 was repeated by preparing a series of electrophoretic media were prepared using the white dispersion from Example 3B and charge control agent from Comparative Example 1. In Comparable Example 13, the minimum zeta potential was −42.2 cV.

Comparative Example 14: The procedure of Example 10 was repeated by preparing a series of electrophoretic media were prepared using the white dispersion from Example 4B and charge control agent from Comparative Example 1. In Comparable Example 14, the minimum zeta potential was −24.1 eV.

Comparative Example 15: The procedure of Example 10 was repeated by preparing a series of electrophoretic media were prepared using the white dispersion from Example 5B and charge control agent from Comparative Example 1. In Comparable Example 13, the minimum zeta potential was −62.3 eV.

Example 16: The procedure of Example 10 was repeated by preparing a series of electrophoretic media were prepared using the cyan dispersion from Example 6B and charge control agent from Example 2. In Example 16, the minimum zeta potential was 75.6 cV.

Example 17: The procedure of Example 10 was repeated by preparing a series of electrophoretic media were prepared using the magenta dispersion from Example 7B and charge control agent from Example 2. In Example 17, the maximum zeta potential was 58.4 cV.

Example 18: The procedure of Example 10 was repeated by preparing a series of electrophoretic media were prepared using the yellow dispersion from Example 8B and charge control agent from Example 2. In Example 18, the minimum zeta potential was −20.4 cV.

Comparative Example 19: The procedure of Example 10 was repeated by preparing a series of electrophoretic media were prepared using the cyan dispersion from Example 6B and charge control agent from Comparative Example 1. In Example 19, the maximum zeta potential was 70.0 eV.

Comparative Example 20: The procedure of Example 10 was repeated by preparing a series of electrophoretic media were prepared using the magenta dispersion from Example 7B and charge control agent from Comparative Example 1. In Example 20, the maximum zeta potential was 56.0 eV.

Comparative Example 21: The procedure of Example 10 was repeated by preparing a series of electrophoretic media were prepared using the yellow dispersion from Example 8B and charge control agent from Comparative Example 1. In Example 21, the minimum zeta potential was −25.2 eV.

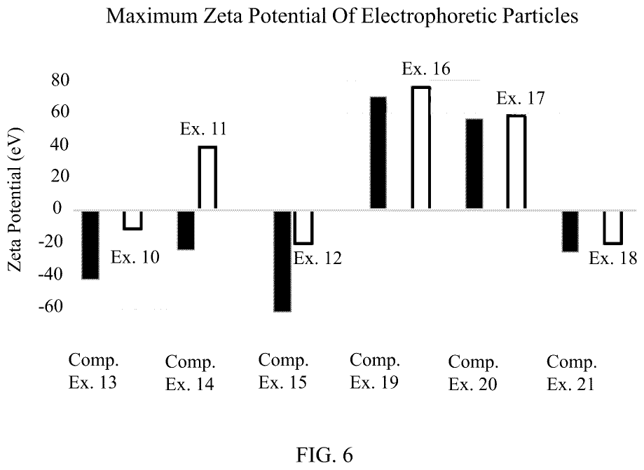

The results of the determination of maximum particle zeta potentials of the charged particles of Examples 10-12, 13-15, and Comparative Examples 13-15, 19-21 are provided in Table 1 and FIG. 6. The black bars of FIG. 6 correspond to the comparative examples, whereas the white bars of FIG. 6 correspond to the black bars.

TABLE 1
Maximum Zeta Potentials of Various Electrophoretic
Charged Particles in Electrophoretic Media.

| | | | Particle |
|---|---|---|---|
| | | | Maximum |
| | | | Positive or |
| | | | Minimum |
| | | | Negative |
| | | | Zeta Potential |
| Example No. | CCA From | Color of Particles | (eV) |
| Ex. 10 | Ex. 2 | White from Ex. 3B | −11.2 |
| Comp. Ex. 13 | Comp. Ex. 1 | White from Ex. 3B | −42.2 |
| Ex. 11 | Ex. 2 | White from Ex. 4B | 38.6 |
| Comp. Ex. 14 | Comp. Ex. 1 | White from Ex. 4B | −24.1 |
| Ex. 12 | Ex. 2 | White from Ex. 5B | −20.6 |
| Comp. Ex. 15 | Comp. Ex. 1 | White from Ex. 5B | −62.3 |
| Ex. 16 | Ex. 2 | Cyan from Ex. 6B | 75.6 |
| Comp. Ex. 19 | Comp. Ex. 1 | Cyan from Ex. 6B | 70.0 |
| Ex. 17 | Ex. 2 | Magenta from Ex. 7B | 58.4 |
| Comp. Ex. 20 | Comp. Ex. 1 | Magenta from Ex. 7B | 56.0 |
| Ex. 18 | Ex. 2 | Yellow from Ex. 8B | −20.4 |
| Comp. Ex. 21 | Comp. Ex. 1 | Yellow from Ex. 8B | −25.2 |

The zeta potential data of Table 1 and FIG. 6 for the white charged pigment particles (Examples 1-12 and Comparative Examples 13-15) show that inventive charge control agent (CCA) from Example 2 interacts with the pigment particles types differently, depending on the nature of the surface of the particles type, as opposed to comparative CCA. Specifically, inventive CCA from Example 2 provides white particles with zeta potential (negative or positive), the zeta potential being significantly less negative (or even positive) than the zeta potential of the same white particles in the presence of the comparative CCA from Example 1, as seen in FIG. 6. That is, the zeta potential of the particles of inventive Examples 10 and 12 are much less negative than the zeta potential of the particles of Comparative Examples 13 and 15 respectively, even if they contain the same electrophoretic particles (from Examples 3 and 5 respectively). Analogously, the zeta potential of the particles of inventive Example 11 is positive in comparison to negative zeta potential of the particles of Comparative Examples 14, although Example 11 and Example 14 contain the same electrophoretic particles from Example 4. On the other hand, the inventive CCA and the comparative CCA provide media having particles with very similar zeta potentials to each other for the other three charged particles types (cyan, magenta, and yellow), as can be seen in FIG. 6 (zeta potential of Examples 16, 17, and 18 versus zeta potentials of Comparative Examples 19, 20, and 21 respectively). That is, the current invention provides a useful tool to a skilled person to design an electrophoretic medium having the desired zeta potential of one type of charged particles, without affecting the zeta potentials of the other types of charged particles, by selecting the inventive CCA. This enables a better control of the electro-optic performance of the corresponding electro-optic display. In the Examples presented above, the surface of all of the white particles is acidic, while the surfaces of the yellow, cyan, and yellow particles are less acidic, neutral, or basic. Given the fact that a skilled person is able to select the appropriate particle surface acidity/basicity of the various charged particles of an electrophoretic medium, it becomes clear that the inventive CCA can enable improved electro-optic performance of a variety of electrophoretic systems.

### Zeta Potential Determination of Charged Pigment Particles

The zeta potential of the pigment particles of the electrophoretic media from Examples 10, 11, 12, 16, 17, 18, and Comparative Examples 13, 14, 15, 19, 20, and 21 were measured using a Colloidal Dynamics AcoustoSizer II and ZetaProbe. The results of maximum values for each type of charged particles are provided in the Graph of FIG. 6 and in Table 1.

### III. Preparation of Electrophoretic Medium and Electro-Optic Displays Having Multiple Types of Pigment Particles

### Example 22

An electrophoretic medium was prepared using charged particle dispersion from Example 3B, Example 6B, Example 7B, Example 8B, and charge control agent from Example 2. The electrophoretic medium was used to prepare an electro-optic display illustrated in FIG. 3.

### Comparative Example 23

An electrophoretic medium was prepared using charged particle dispersion from Example 3B, Example 6B, Example 7B, Example 8B, and charge control agent from Comparative Example 1. The electrophoretic medium was used to prepare an electro-optic display illustrated in FIG. 3.

TABLE 2
Color Gamut of Inventive and Control Electrophoretic Displays

| | | Color Gamut | Color Gamut | Color Gamut |
|---|---|---|---|---|
| Example No. | CCA From | 0° C. | 25° C. | 50° C. |
| Ex. 22 | Ex. 2 | 22,603 | 36,535 | 23,314 |
| Comp. Ex. 23 | Comp. Ex. 1 | 16,621 | 24,767 | 9,300 |

### Determination of Color Gamut of Electro-Optic Displays

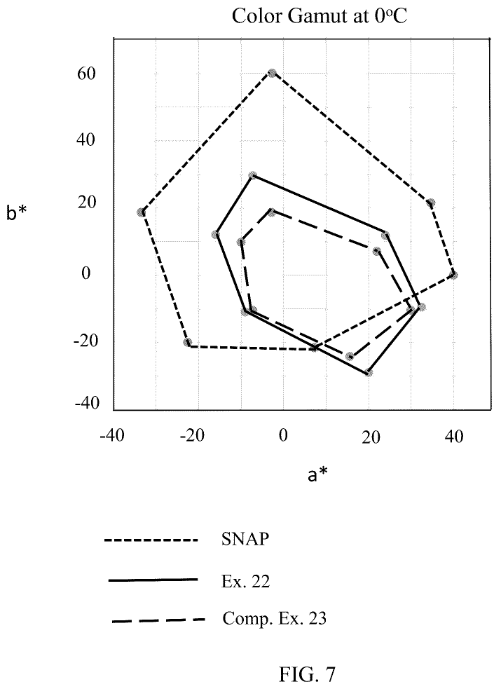

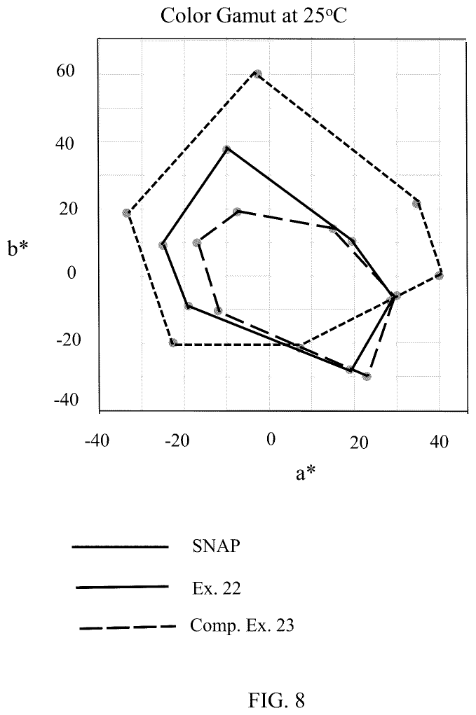

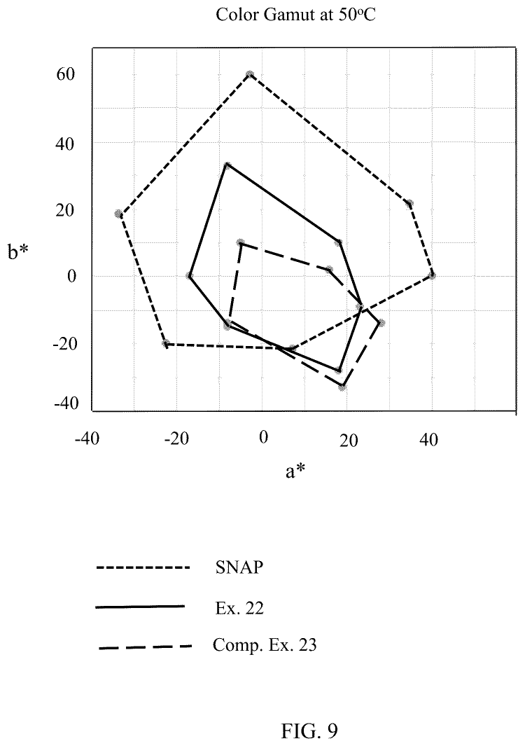

Each of the electro-optic displays from Example 22 and Comparative Example 23 was electrically driven to generate various optical states, the reflection spectra of which were acquired using a spectrophotometer. CIE L*, a* and b* values of the reflected light from each electrophoretic display were measured for the yellow, red, magenta, blue, cyan, and green states. For each spectral sample, the minimum distance in L*a*b* space of the color of the display from each of the SNAP (Specifications for Newsprint Advertising Production) color standard primaries was calculated in units of ΔE*. The full color gamut from all measured points was also extracted. The lower the distance, the closer is the performance of the electrophoretic display to the SNAP target, indicating better color saturation of the optical state of the display. The color gamut for electro-optic displays from Example 22 and Comparative Example 23 was determined for three different temperatures (0° C., 25° C., and 50° C.). The results of color gamut at the three temperatures are summarized in Table 2 and FIGS. 7, 8, and 9 respectively. The solid line of the figures corresponds to the gamut of the electro-optic display that includes electrophoretic medium having the inventive charge control agent from Example 2. The short dotted line of the figures corresponds to the color standard (SNAP), whereas the long dotted line of the figures correspond to the gamut of the electro-optic display that includes electrophoretic medium having the comparative charge control agent from Comparative Example 1.

It is concluded from the color gamut values of Table 2 and the graphs of FIGS. 7-9 that the use of inventive charge control agents having a molecular structure comprising (1) a quaternary ammonium functional group or an imidazolium cation, (2) a hydrophobic tail, and (3) a counter ion, the counter ion of the charge control agent being an anion, the anion being a conjugate base of an acid, the acid having a pKa of less than or equal to −2.5, provides a broader color gamut to the electro-optic display having electrophoretic medium that comprises the control charge control agent. In addition, the improved color gamut is observed at a wide temperature range (0° C. to 50° C.)

We claim:

1. An electrophoretic medium comprising a plurality of charged particles, a charge control agent, and a non-polar liquid, the charge control agent has a molecular structure comprising a quaternary ammonium functional group or an imidazolium cation, a hydrophobic tail, and a counter ion, the counter ion of the charge control agent being an anion, the anion being a conjugate base of an acid, the acid having a pKa of less than or equal to −2.5, wherein the plurality of charged particles are capable of moving through the non-polar liquid upon application of an electric field.

2. The electrophoretic medium of claim 1, wherein the counter ion of the charge control agent is an anion, the anion being a conjugate base of an acid, the acid having a pKa of from −2.5 to −16.

3. The electrophoretic medium of claim 1, wherein the counter ion of the quaternary ammonium functional group or the counter ion of the imidazolium cation is selected from the group consisting of trifluoromethanesulfonate, bis(trifluoromethane)sulfonamide, sulfate, perchlorate, chloride, bromide and iodide.

4. The electrophoretic medium of claim 1, wherein the charge control agent has a weight average molecular weight that is greater than or equal to 1000 g/mol.

5. The electrophoretic medium of claim 1, wherein the charge control agent is a molecule selected from a group consisting of a branched polyethylenimine derivative, a molecule that is represented by Formula I, a molecule that is represented by Formula II, a molecule that is represented by Formula III, a molecule that is represented by Formula IV, and a molecule that is represented by Formula V, 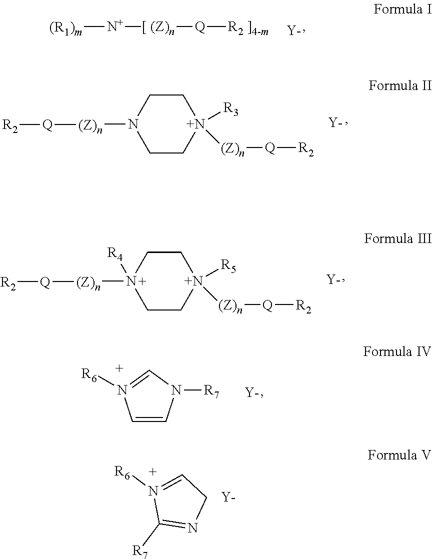
wherein
the branched polyethylenimine derivative has a molecular structure comprising one or more quaternary ammonium functional groups and one or more hydrophobic moieties;
R₁ is independently selected from the group consisting of an aryl group and an alkyl group, the alkyl group having from 1 to 10 carbon atoms;
m is an integer from 0 to 3;
Z is one of a branched or nonbranched alkanediyl group;
n is an integer from 3 to 20;
Q is a moiety selected from the group consisting of an ester, a thioester, an amide, an imide, a urea, and a carbamate;
R₂ is a hydrophobic moiety;
R₃, R₄, and R₅, are selected from the group consisting of an alkyl group having from 1 to 20 carbon atoms and an aryl group;
each R₆, and R₇ are independently selected from the group consisting of an alkyl group having from 1 to 20 carbon atoms, an aryl group, and —(Z)ₙ-Q-R₂, and at least one of R₆ and R₇ is —(Z)ₙ-Q-R₂; and
Y— is the counter ion.

6. The electrophoretic medium of claim 5, wherein of the hydrophobic moiety of the branched polyethylenimine derivative and the hydrophobic moiety R₂ of Formulas I to V are selected from an alkyl group, an alkenyl group, a polyester, a polyether, a polyamide, a polyurethane, a polyurea, a polyacrylate, a methacrylate, a polydimethylsiloxane, and combinations thereof.

7. The electrophoretic medium of claim 5, wherein the hydrophobic moiety R₂ of Formulas I to V has from 50 to 1000 carbon atoms or from 10 to 300 dimethylsiloxane groups.

8. The electrophoretic medium of claim 5, wherein the hydrophobic moiety of the branched polyethylenimine derivative and the hydrophobic moiety R₂ of Formulas I to V is derived from a monomer selected from the group consisting of ricinoleic acid, isobutylene, hydroxystearic acid, and combinations thereof.

9. The electrophoretic medium of claim 5, wherein the charge control agent is a branched polyethylenimine derivative having more than one hydrophobic moieties and one or more quaternary ammonium functional groups, wherein the branched polyethylenimine derivative is formed from a branched polyethylenimine having primary, secondary, and tertiary amino functional groups, wherein the more than one hydrophobic moieties of the branched polyethylenimine derivative are formed by a reaction of the primary and/or secondary amine groups with a monomer selected from the group consisting of ricinoleic acid, isobutylene, hydroxystearic acid, and combinations thereof, and wherein the more than one quaternary ammonium functional groups of the branched polyethylenimine derivative are formed by alkylation reaction of tertiary amino functional groups of the branched polyethylenimine.

10. The electrophoretic medium of claim 9, wherein the counter ion of the quaternary ammonium functional groups of the branched polyethylenimine derivative is selected from the group consisting of trifluoromethanesulfonate, bis(trifluoromethane)sulfonamide, sulfate, perchlorate, chloride, bromide and iodide.

11. The electrophoretic medium of claim 9, wherein the number average molecular weight of the branched polyethylenimine derivative is higher than 1,000 g/mole.

12. The electrophoretic medium of claim 5, wherein the charge control agent is a molecule that is represented by Formula VI or Formula VII; 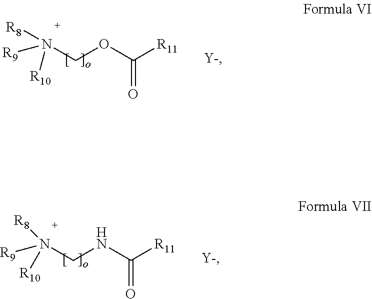
wherein each R₈, R₉, R₁₀ is independently selected from the group consisting of an alkyl group, the alkyl group having from 1 to 10 carbon atoms;
wherein o is an integer from 3 to 10;
wherein R₁₁ is a hydrophobic moiety, the hydrophobic moiety being selected from an alkyl group, an alkenyl group, a polyester, a polyether, a polyamide, a polyurethane, a polyurea, a polyacrylate, a methacrylate, a polydimethylsiloxane, and combinations thereof; and
wherein the counter ion is selected from the group consisting of trifluoromethanesulfonate, bis(trifluoromethane)sulfonamide, sulfate, perchlorate, chloride, bromide and iodide.

13. The electrophoretic medium of claim 12, wherein R₈, R₉, R₁₀ of Formulas VI and VII are methyl groups, and wherein the hydrophobic moiety R₁ of Formulas VI and VII comprises a functional group selected from the group consisting of poly(hydroxystearic acid), poly(ricinoleic acid), and poly(isobutylene).

14. The electrophoretic medium of claim 12, wherein the charge control agent is a molecule that is represented by Formula VIII or Formula IX, 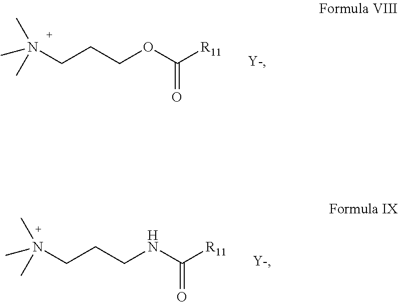
wherein R₁₁ is a hydrophobic moiety comprising a functional group selected from the group consisting of poly(hydroxystearic acid), poly(ricinoleic acid), and poly(isobutylene), and wherein the counter ion is trifluoromethanesulfonate.

15. The electrophoretic medium of claim 5, wherein the charge control agent is a molecule that is represented by Formula X or Formula XI; 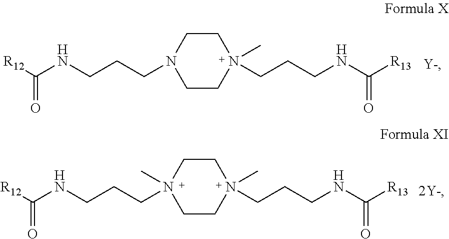
wherein R₁₂ and R₁₃ are hydrophobic moieties comprising a functional group selected from the group consisting of poly(hydroxystearic acid), poly(ricinoleic acid), and poly(isobutylene), and wherein the counter ion is trifluoromethanesulfonate.

16. The electrophoretic medium of claim 5, wherein the charge control agent is a molecule that is represented by Formula XII, 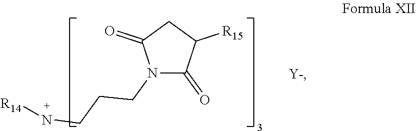
wherein R₁₄ is an alkyl group, the alkyl group having from 1 to 10 carbon atoms, and wherein R₁₅ is a hydrophobic moiety comprising a functional group selected from the group consisting of poly(hydroxystearic acid), poly(ricinoleic acid), and poly(isobutylene), and wherein the counter ion is trifluoromethanesulfonate.

17. The electrophoretic medium of claim 5, wherein the charge control agent is a molecule that is represented by Formula XIII, 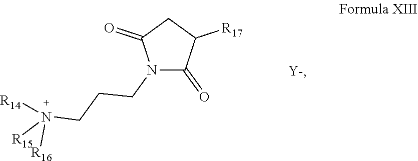
wherein each R₁₆, R₁₇, R₁₈ is independently selected from the group consisting of an alkyl group, the alkyl group having from 1 to 10 carbon atoms, and wherein R₁₉ is a hydrophobic moiety comprising a functional group selected from the group consisting of poly(hydroxystearic acid), poly(ricinoleic acid), and poly(isobutylene), and wherein the counter ion is trifluoromethanesulfonate.

18. The electrophoretic medium of claim 1, further comprising a second charge control agent, wherein the second charge control agent comprises a hydrophobic moiety and a head group, the head group being selected from the group comprising an anionic functional group, a nonionic functional group, and a cationic functional group.

19. The electrophoretic medium of claim 18, wherein the head group of the second charge control agent comprises an ammonium cation or an acyclic secondary amide group.

20. An electro-optic display comprising a first electrode layer, an electro-optic material layer, and a second electrode layer, the first electrode layer being light transmissive, the second electrode layer comprising a plurality of pixel electrodes, the electro-optic material layer comprising a plurality of microcapsules or a plurality of microcells, each microcapsule or microcell comprising the electrophoretic medium of claim 1, wherein the electro-optic material layer is disposed between the first electrode layer and the second electrode layer, and wherein the first electrode layer and the second electrode layer are configured to apply an electric field across the electro-optic material layer.
